(19) United States
(12) Patent Application Publication
(10) Pub. No.: US 2003/0064293 A1
(43) Pub. Date: Apr. 3, 2003

(54) Holographic recording medium

(75) Inventors: Stephen Elliott, Cambridge (GB); Pavel Krecmer, Cambridge (GB); Jiri Prokop, Cambridge (GB)

Correspondence Address: SUGHRUE MION, PLLC, 1010 EL CAMINO REAL, SUITE 300, MENLO PARK, CA, 94025, US

(73) Assignee: POLIGHT TECHNOLOGIES LTD., Cambridge (GB)

(21) Appl. No.: 10/165,778

(22) Filed: Jun. 7, 2002

(30) Foreign Application Priority Data
Sep. 7, 2001 (GB) 0121726.4
Dec. 3, 2001 (GB) 0128904.0

(51) Int. Cl. G03H 1/04; G11B 7/24

(52) U.S. Cl. 430/1; 430/2; 359/7; 430/270.13; 430/945

(57) ABSTRACT

A holographic recording medium comprising an amorphous host material which undergoes a phase change from a first to a second thermodynamic phase in response to a temperature rise about a predetermined transition temperature; a plurality of photo-sensitive molecular units embedded in the host material and which can be orientated in response to illumination from a light source; whereby said molecular units may be so orientated when said host material is at a temperature equal to or above said transition temperature but retain a substantially fixed orientation at temperatures below said transition temperature.

### FIELD OF THE INVENTION

The present invention relates generally to materials used for forming photorefractive holographic recording media. The invention relates in particular to a method for producing a photorefractive holographic media which has good sensitivity and good transparency to enable thick samples to be used for multiplexing multiple pages of data.

### BACKGROUND TO THE INVENTION

Data storage based on two-dimensional (2D) memories, such as optically read/write pits, grooves or magnetic domains are reaching the theoretical limits of the given materials. New techniques are being sought in order to decrease the price per megabyte and increase the data storage capacity and speed of data recording and retrieval of near-future disk drives by several orders of magnitude. The technical solutions to the problem are essentially three-fold. Firstly, decreasing the pit and groove sizes to several nanometres would reach the limit of 10¹⁰-10¹² bits/mm². Such a solution is, however, inevitably limited by costly precision mechanics, need for special environments (high-vacuum or pure liquid state) and most importantly, extra long access time to stored data due to the inherent disadvantage of 2D technology- very slow, serial reading.

The second technical solution to the increasing demands for data-storage systems is being developed on the basis of three-dimensional optical writing of pits and grooves into a series of multi-layers. Instead of one layer in today's CDs or two layers in today's DVDs, multi-layer disks are being considered using, for example, photorefractive polymers as discussed by D. Day, M. Gu and A. Smallridge (Use of two-photon excitation for erasable-rewritable three-dimensional bit optical data storage in a photorefractive polymer, Optics Letters 24 (1999) 948) or fluorescent materials. This technical solution to the data-storage problem also has severe disadvantages such as the limited number of sensitive layers due to overlapping problems (noise due to interference and scattering) and still, most importantly, slow serial data processing.

The third category of technical approach to data-storage systems for future recording media is in holographic data recording and retrieval. There has been growing interest in the use of holography for information storage due to its massively parallel data processing and prospect of reaching the ultimate theoretical limits of the material used for the storage. Used for storage of digital information, holography is now regarded as a realistic contender for functions now served by opto-magnetic materials or optically written phase-change CD-ROMs and DVD-ROMs.

Much research has been carried out to find a suitable and commercially viable recording medium. Virtually any photo-sensitive material can be used for holographic recording; however, long-time data storage, sensitivity, cost, speed of recording and developing of the holograms are only some of the issues which limit the available materials to a few which are potentially useful in the field of holographic data storage. Typical materials extensively used in, for example, art holography, such as silver-halide materials, dichromated gelatin, bacteriorhodopsin etc. are generally unsuitable for data storage, as they typically require additional processing steps such as wet development. Thus, there are, in principle, three major groups of materials being extensively studied at present.

Ion-doped inorganic photorefractive crystals, such as lithium niobate, have served for laboratory use for many years. Interfering light beams of suitable wavelength generate bright and dark regions in the electro-optic crystal and charge carriers—usually electrons—are excited in the bright regions and become mobile. They migrate in the crystal and are subsequently trapped at new sites. By these means, electronic space-charge fields are set up that give rise to a modulation of refractive index via the electro-optic effect.

Disadvantages of these materials include high cost and poor sensitivity resulting in a need for very high light power densities, limited refractive index changes (less than 10⁻³), restriction to small samples (single crystals), the volatility of the stored data and the necessity of thermal fixing by heating the crystal to 100-129° C. after recording and the danger of noise due to damage inflicted during read-out.

Polymer recording is promising and is gaining increased popularity due to the simple method of preparation and relatively low cost. Several physical principles are utilised in polymer recording. Photopolymers or photoaddressable polymers react to light with a refractive index change caused by a change in their molecular configuration resulting from polymerisation. Photorefractive polymers utilise the same electro-optic effect as described above in the case of photorefractive crystals.

The major disadvantage of the monomer-polymer type material is the significant distortions of the holograms due to polymer shrinkage during polymerisation. Photoaddressable—photochromic and photodichroic polymers that undergo a change in isomer state after two-photon absorption are the subject of extensive study. These materials are reversible and relatively fast (msec); however, disadvantages typically include relatively fast dark relaxation, short dark storage time and the requirement of coherent UV light sources. Photorefractive polymers exhibit quite a high dynamical range with low intensity illumination, but still suffer from disadvantages like problematic preparation of thick samples, need for development of non-destructive readout and the necessity to apply a high electrical field for the transport and charge separation.

Organic polymers are generally also limited in having relatively low light intensity thresholds due to possible overheating (resulting in chemical decomposition).

The final class of materials that can be used for holographic data storage are chalcogenide glasses, and these form the subject of this application.

There are six basic phenomena exhibited by chalcogenide glasses, which can be potentially used for data storage eg. holographic recording:

1. the phase change (photocrystallisation),

2. photodoping of chalcogenides with metallic materials which are in direct contact with the sample (e.g. silver, copper etc.)

3. photoinduced expansion and contraction of the glassy matrix,

4. wet etching of the exposed/nonexposed areas of the chalcogenide glass in solvents

5. photoinduced anisotropy (the change of refractive index (birefringence) and absorption coefficient (dichroism) upon absorption of polarized light),

6. Scalar photodarkening/photobleaching (the change of absorption coefficient and refractive index upon absorption of unpolarized light),

The first group consists of optical recording media, which exhibit a phase-change (amorphous-to-crystal, or vice versa) upon illumination or heating. It is well known that some kinds of Te-based alloy film undergo comparatively easily a reversible phase transition on irradiation by a laser beam. Since, among them, compositions rich in Te-component makes it possible to obtain an amorphous state by illumination with a relatively low laser power, their application as a recording medium has been proposed. For example, S. R. Ovshinsky et al. had first disclosed in U.S. Pat. No. 3,530,441 that thin films such as Te₈₅ Ge₁₅ and Te₈₁Ge₁₅S₂Sb₂ produce a reversible phase-transition when exposed to light with a high energy density such as a laser beam. A. W. Smith has also disclosed a film of Te₉₂Ge₃As₅ as a typical composition, and he has clarified that it could undergo about 10⁴ recording (amorphization) and erasing (crystallization) cycles (Applied Physics Letters, 18 (1971) p. 254). However, since the crystalline phase causes a high degree of light scattering, these materials are generally not well suited for holographic recording.

Many studies have been made on light-sensitive materials, which make use of the photodoping phenomenon. When a light-sensitive recording material comprising laminated layers of a chalcogenide film and a metallic layer are subjected to appropriate irradiation, a metal diffusion in the chalcogenide (photodoping) is caused in the irradiated areas, thus yielding an image corresponding to the light irradiation pattern. [Soviet Physics Solid State, Vol. 8, p. 451 (1966), U.S. Pat. Nos. 3,637,381 and 3,637,383, Japanese Patent Publication 6,142/72]. The resulting image can either be used as such, utilizing the absolute contrast between fully opaque (non-irradiated) and transparent areas (illuminated) of the sample (amplitude image), or make use of the diffusion implicated differences in the solubility of the exposed and non-exposed areas in suitable solvents. Although this is potentially interesting in write-once-read-many (WORM) type of memories, this effect is generally slow and mostly limited to surface relief holograms. Another disadvantage of these materials is firstly the high mobility of the small metal-ions (mostly Ag) in the host material, which causes a relatively fast degradation of the optical properties of the sample. Secondly, in order to make use of the refractive index changes in the material, the non-dissolved metal at the non-illuminated areas of the sample has to be removed in an additional process step [C. W. Slinger, A. Zakery, P. J. S. Ewen and A. E. Owen, Photodoped chalcogenides as potential infrared holographic media, Applied Optics 31 (1992) 2490].

The photoinduced expansion/contraction of the glassy matrix can be used for the formation of relief holographic gratings in thin chalcogenide films. Though it might play an important role in fundamental understanding of photostrucural changes, it is rather a negative effect affecting the process of holographic recording in chalcogenide glasses. Fortunately it requires high exposure energies (200-300 J/mm²) to significantly affect the surface relief of the sample. [V. Paylok, Appl. Phys. A 68 (1999) 489, S. Ramachandran, IEEE Photonics Tech. Lett.,8, 1996].

Wet etching of photo-induced holograms in chalcogenide glasses is another approach—T. Sakai and Y. Utsugi [Opt. Comm. 20 (1977) 59] copied holograms using amorphous chalcogenide semiconductor films as a master, utilizing the feature of a chalcogenide glass to act as an effective inorganic photoresist, where illuminated or unilluminated areas of the sample are vulnerable to solvents (both positive and negative processes being used). This effect has the potential for use in making holographic master elements for polymer endorsing; however, it is generally unsuitable for holographic data storage, as it requires long times for the development of the recorded data.

Photoinduced anisotropy, i.e.optical changes under illumination with polarized light (i.e. optically induced birefringence and dichroism) are the next group of optical properties in chalcogenide glasses that can be used for hologram writing. A change of refractive index of about ˜3.10⁻³ in an amorphous As₂S₃ film was first observed in 1977 by Zhdanov and Malinovsky [V. G. Zhdanov and V. K. Malinovsky, Pisma Zh. Tehn. Fiz. 3 (1977) 943], and nearly 100 research papers have been published on the subject since. The structural changes associated with photoinduced anisotropy are the subject of speculations; however, it is generally accepted that the structural origin of the photoinduced anisotropy is different in nature from that of scalar photodarkening. Reorientation of charged atomic defects, orientation of molecular or other structural units in the glassy matrix and a change in bond-angle distributions are all being equally considered as the origin of photoinduced anisotropy. The first holographic recording in chalcogenide glasses based on photoinduced anisotropy was performed by Kwak at al [C. H. Kwak, J. T. Kim and S. S. Lee, Scalar and vector holographic gratings recorded in photoanisotropic amorphous As₂S₃ thin films, Optics Lett. 13 (1988) 437]. The maximum diffraction efficiency (˜0.2%) obtained with an Ar-ion laser beam (514 nm) and 50 mW/cm² light intensity, was reached in the order of tens of seconds in C. H.Kwak, J. T. Kim and S. S.Lee, Scalar and vector holographic gratings recorded in a photoanisotropic amorphous As₂S₃ thin films, Optics Lett.13 (1988) 437. The effect is essentially reversible and this is achieved by changing the orientation of the linearly polarized light to the orthogonal direction to that of the original inducing beam. Similar characteristic performances of holographic writing of diffraction elements (diffraction efficiency of order of <5%) with polarized light have been reported later.

Scalar photodarkening/photobleaching (i.e. a photoinduced change in optical properties independent of the polarization of the inducing light) is believed in the related art to be caused by one or more combinations of the following processes: atomic bond scission, change in atomic distances or bond-angle distribution, or photoinduced chemical reactions such as

2As₂S₃<->2S+As₄S₄

Most recording materials for holograms based on chalcogenide glasses take advantage of differences in the light absorption between irradiated areas and non-irradiated areas [Applied Physics Letters, Vol. 19, p. 205 (1971) U.S. Pat. No. 3,923,512, UK Patent GB-1387 177]. The method comprises exposing a chalcogenide layer to a pattern of light having wavelengths less than that corresponding to the bandgap of the material whereby the optical density of the material is increased or decreased in the areas exposed to light to form a visible image.

The changes in absorption coefficient are mainly accompanied by a change in refractive index. This is typically greater than that in photorefractive crystals or polymers and can reach up to Δn˜0.2-0.3 (for comparison Fe-doped LiNbO₃ ferroelectric crystals have Δn˜10⁻⁴). In the early 1970s, reversible photoinduced shifts of the optical absorption of vitreous As₂S₃ films were reported and used for hologram storage in these materials [U.S. Pat. No. 3,923,512, Ohmachi, Appl. Phys. Lett., 20 1972, J. S.,Berkes J.Appl.Phys, 42, 5908, K. Tanaka, Solid St. Commun., 11,1311]. Typical diffraction efficiencies of several percent for exposure with 15 mW laser power (Ar-ion laser) in 10 sec, with stable dark data storage over 2,500 hours, were reported in As₂S₃ films [S. A.Keneman, Appl.Phys.Lett. 19 (6) 1971]. Similar results of holographically written gratings (or other holographic elements) based on the principle of photodarkening/photobleching in chalcogenide glasses were later reported by various researchers [PNr.SU474287, SU697958-1980, SU704396-1982, SU-1100253, SU1833502-1995, O.Salminen, Opt. Commun.116 (1995) 310, ].Since the maximum diffraction efficiency of an amplitude grating (based on changes in optical density) is principally much lower than that of a phase grating, it is desirable to minimize the light attenuation caused by a high degree of optical absorption of the chalcogenide layer.

As the required data storage density rapidly increases, the need for thick recording media becomes inevitable. The effective areal storage density can be significantly increased by recording of multiple, independent pages of data in the same recording volume. This process, in which the holographic structure for one page is intermixed with the recorded structure of each of the other pages, is referred to as multiplexing. Retrieval of an individual page with minimum crosstalk from the other pages is a consequence of the volume nature of the recording and its behavior as a highly tuned diffracting structure. This so called Bragg effect is the cause of a decrease in diffraction intensity by changing the angle or wavelength between different recording and playback beams. The point at which the diffraction efficiency becomes zero depends on the recording angles, initial wavelength and optical thickness of the recording material. For a given recording configuration, altering the thickness plays the central role. As the thickness increases, the recorded structure becomes more highly tuned such that smaller mismatches among individual holograms can be tolerated.

According to Kogelnik's coupled wave theory [H. Kogelnik, Bell.Syst. Tech. J.48, 2909 (1996)] multiple holograms can be stored in a 10 μm thick recording medium (λ=532 nm, θₑₓₜ(object beam)=θₑₓₜ(reference beam)=45°, n=1.5 in angular increments of 3°0 while a 100 μm thick medium allows storage in 0.3° angular increments. Since the diffraction efficiency η of a hologram is defined as the ratio of the diffracted power to the incident power, a small value of the optical absorption coefficient α is also desirable to achieve high diffraction efficiencies by minimising absorption losses and maximising optical transmission. The major drawback of the proposed recording media utilising chalcogenide glasses is their high optical absorption (compositions from the systems As—S, As—Se, As—Ge—S, As—Ge—Se, Ge—Se) or low sensitivity (compositions from the systems Ge—S, Ge—Sb—S) for the wavelength of the commercially most available Nd-YAG laser (λ=532 nm). If this problem were to be overcome, chalcogenides could be used for optical data storage in future optical discs.

If most known chalcogenide glasses were to be used in a commercial holographic drive (“holodrive”) they would require the use of very expensive tunable pulsed lasers emitting light having a relatively low energy (ie longer wavelength). This is due to these materials having relatively small values of energy band gaps, thereby exhibiting high optical absorption of the output of higher energy, shorter wavelength lasers. The laser system would need to be tuned to bandgap or near the bandgap of the chalcogenide material, while at the same time retaining a high value of optical transmission—two conditions which are in principle contradictory and almost impossible to achieve in optically thick media (above 100 μm thick). Pulsing of the write laser is crucial for commercial applications of holographic data storage, as fast writing speeds are dependent on pulsing of the laser if the response time of the storage medium is to be fast enough. It is a non-trivial task to construct a pulsed laser operating at an arbitrary wavelength (or energy). There are fundamental limitations which, in principle, limit the choice to only a few distinct wavelengths. It is believed that the strongest contender for commercially suitable holodrives is the frequency doubled Nd:YAG laser (λ=532 nm).

In our co-pending British patent application number 0121726.4, we disclose a holographic recording medium comprising a sulphur based chalcogenide glass containing phosphorus. This material has been found to be superior to previously used chalcogenide glasses , in that the sensitivity of the glass to a Nd:YAG laser is high and at the same time the optical absorption at λ=532 nm of Nd:YAG laser light is comparatively low, enabling samples of >100 μm to be produced which have an optical transmissivity greater than 50%. The low value of optical absorption is due to the material having a larger bandgap than previously used chalcogenide glasses, and moreover the bandgap can be tuned to a slightly shorter wavelength than 532 nm to decrease the absorption of Nd:YAG laser light without substantially affecting the sensitivity. Nd:YAG lasers are relatively cheap and can be pulsed. The use of phosphorus containing sulphur based chalcogenide glass potentially can achieve the fast writing speeds which are essential in a commercially viable holographic storage medium. However, even with the use of this new chalcogenide material, it would still be desirable to obtain even thicker samples (of the order of 0.5 mm) to increase the multiplexing capability.

WO01/45111 discloses a rewriteable chalcogenide based holographic recording medium which particularly utilises an As—Se based chalcogenide material. This recording medium requires the use of a He—Ne laser (λ=632.8 nm) as the bandgap of the material is rather small and the optical absorption of a Nd:YAG laser beam would be too high to obtain the necessary depth of optical penetration for recording multiple pages of data in thick samples.

The object of this invention is the utilization of a highly photosensitive composition of an amorphous chalcogenide material in the form of a relatively thick film (d>100 μm) for the preparation of a volume holographic recording medium with high diffraction efficiency, which allows multiple holograms to be stored, the material having a high level of optical transmission at the wavelength of interest.

### SUMMARY OF THE INVENTION

According to the present invention, a holographic recording medium comprises an amorphous mixture of a chalcogenide glass dispersed in a filler material, the filler material being substantially transparent to visible light, wherein the chalcogenide glass undergoes a photostructural change in response to illumination resulting in a change of refractive index of the chalcogenide glass.

According to the present invention, a method of producing a holographic recording medium comprises the step of:

co-depositing a chalcogenide material and a filler material onto a substrate to form an amorphous film comprising an amorphous mixture of a chalcogenide glass and a filler material, the filler material being substantially transparent to visible light.

According to the present invention, a method of holographic recording comprises the steps of:

providing a holographic recording medium comprising an amorphous mixture of a chalcogenide glass and a filler material, the filler material being substantially transparent to visible light;

selectively illuminating the holographic recording medium thereby inducing a photostructural change resulting in a change of refractive index of the chalcogenide glass.

The combination of a transparent filler material which is optically inert with the chalcogenide material has the effect of diluting the active chalcogenide material, and thus reducing the overall optical absorption of the mixture to allow a high degree of multiplexing in thick films. This does, of course, reduce the overall sensitivity, but not enough to affect the function of the material as a holographic recording medium. The filler material is optical inert in that it does not exhibit the photostructural effect in response to illumination. For instance, with the type of large bandgap phosphorus and sulphur based chalcogenide glass disclosed in our above-referenced co-pending British Patent application, the transparency is already good at 532 nm (for 100□m thick films), and the sensitivity is very high. The amount of dilution required to obtain thicker samples does not critically affect the sensitivity. This material, when diluted according to the present invention, can achieve sample thicknesses of the order of 0.5 mm with approximately 50% transmissivity at 532 nm.

Furthermore, the dilution of the chalcogenide material leading to a reduction of the overall optical absorption can enable the use of smaller bandgap chalcogenides such as As₂S₃ or materials as described in WO01/45111 such as As—Se glasses enabling the use of higher frequency light which would otherwise be practically impossible (due to very high absorption). This enables the use of frequency doubled Nd:YAG lasers with these materials and at the same time potentially significantly increases the sensitivity of the holographic material. In the diluted material, the 532 nm light can penetrate more deeply, allowing the multiplexing of more pages of data stored holographically.

In the method of producing the holographic recording medium of the present invention, preferably the step of codepositing comprises coevaporating the chalcogenide material and the filler material from separate receptacles and condensing the vapour on the substrate to form the amorphous mixture.

Preferably, the chalcogenide material and the filler are evaporated from separate receptacles, such as crucibles. This prevents chemical reactions taking place in the melt.

Preferably, the filler material comprises a glass. More preferably an oxide, fluoride or chalcogenide glass and most preferably ZnS, YF₃, B₂O₃ or GeO₂.

The glass filler must be transparent to visible light, and preferably has a band gap of at least 2.6 eV.

Preferably, the amorphous chalcogenide mixture contains molecules of A₄B₃ and/or A₄B₄ where A is either phosphorus or arsenic and B is either sulphur, selenium or tellurium. These molecules can be particularly responsible for the photorefractive effect, either by being reoriented in response to illumination by polarised light or by being broken up.

In a preferred embodiment, the chalcogenide glass consists of sulphur, phosphorus and arsenic. The illuminating light causes a breakdown of P₄S₄ and/or P₄S₃ molecules in the glass, producing an irreversible change. This material is useful to produce a WORM (write once read many) type recording medium.

In an alternative, rewriteable medium, molecules of As₄Se₃ are reorientated in response to illumination by polarised light when the medium is heated above the temperature at which a phase change of the molecular units takes place. Cooling sets the reorientated molecule. The recorded data can be erased by heating the recording medium or by using the polarised light with an electric field vector in the orthogonal direction to that used for recording.

### BRIEF DESCRIPTION OF THE DRAWINGS

Examples of the present invention will now be described in detail with reference to the accompanying drawings, in which:

FIG. 1 shows a ternary diagram of As—P—S compositions;

FIG. 2 illustrates diffraction efficiency of a sample of As₂₈S₆₆P₆;

FIG. 3a shows an x-ray diffraction pattern of a thin film of As₄Se₃;

FIG. 3b shows a Raman spectra of a thin film of As₄Se₃;

FIG. 4 shows a holographic recording medium in accordance with the present invention;

FIG. 5 shows a holographic image of the US Air Force military resolution target recorded in a thin film of As₂S₃ diluted with ZnS;

FIG. 6 shows an apparatus used for recording the holographic image of FIG. 5.

FIG. 7A illustrates the absorption profile, chalcogenide content and refractive index change for a homogeously diluted film;

FIG. 7B illustrates the Bragg selectivity of a homogeneously diluted film;

FIG. 7C illustrates the absorption profile, chalcogenide content and refractive index change for a inhomogeously diluted film; and

FIG. 7D illustrates the Bragg selectivity of a inhomogeneously diluted film.

### DETAILED DESCRIPTION

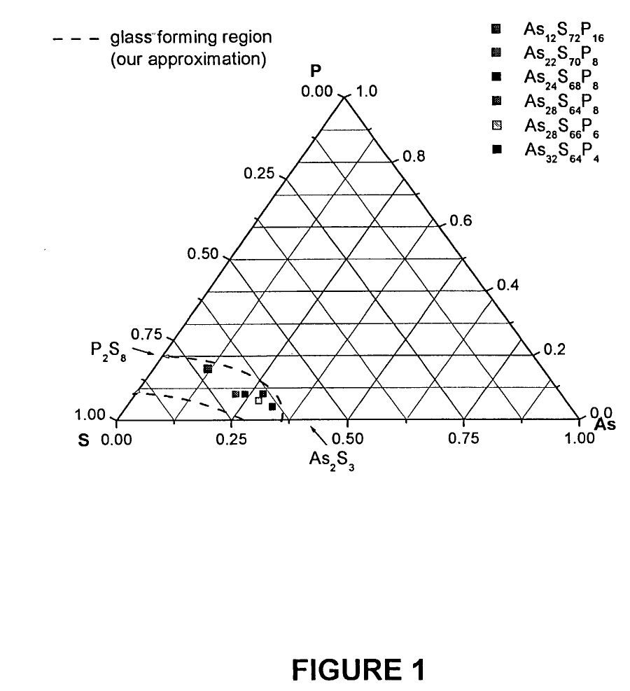

FIG. 1 is a ternary diagram of an As—P—S system, on which approximate boundaries of the glass-forming region are marked. Six example compositions are illustrated, As₁₂S₇₂P₁₆, As₂₂S₇₀P₈, As₂₄S₆₈P₈, As₂₈S₆₄P₈, As₂₈S₆₆P₆ and As₃₂S₆₄P₄. As₂S₃ is also illustrated. All the example compositions which include a component of phosphorus were found to have higher bandgaps and increased sensitivity to a Nd:YAG laser compared to the known and well studied As₂S₃ glass. All the examples also had good transparency at 532 nm.

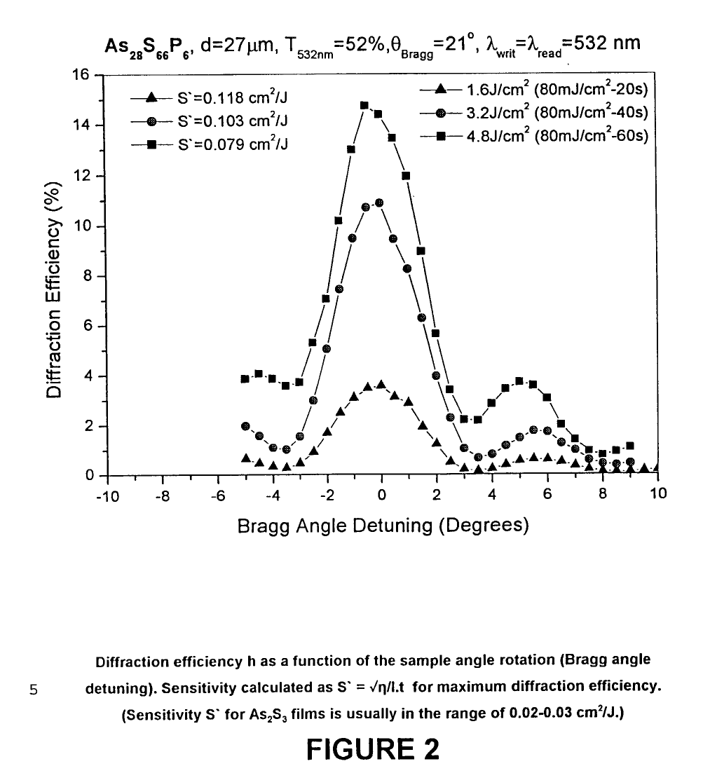

FIG. 2 illustrates the diffraction efficiency of one example, As₂₈S₆₆P₆ for three different exposure times of 20 s, 40 s and 60 s using a Nd:YAG laser of intensity 80 mW/cm². As can be seen, the maximum diffraction efficiency reaches a value of about 15% at an exposure of 4.8 J/cm². The maximum diffraction efficiency obtained with As₂S₃ is typically 0.2% with an Ar-ion laser beam (514 nm) and 50 mW/cm² light intensity, in an exposure time of the order of tens of seconds.

The sensitivity S' of a sample can be calculated as:

S'=\sqrt{η}/I.t

where I is the intensity of the light source, t is the exposure time, and η is the maximum diffraction efficiency. Sensitivities of about 0.1 cm²/J were obtained for the P containing materials. Typical sensitivity values for As₂S₃ samples are in the range 0.02-0.03 cm²/J.

It is believed that the increased sensitivity is related to the formation of thermodynamically stable P₄S₄ and P₄S₃ molecules in the glass. Each of these molecules, due to their inherent atomic structure, possesses a strong dipole moment (inherent or photo-induced). At first, these dipole moments are randomly oriented in the amorphous network. However, it is believed that during the illumination with light, those dipole moments (or molecules) being favorably oriented would couple with interacting photons and the coupling would lead to breakage or reorientation of the molecules. Atoms of these broken molecules would subsequently integrate into the amorphous structure and would then not contribute to a strong overall dipole moment (being the sum of all dipole moments of all molecules and atoms in the amorphous network). During the course of illumination, preferential depletion of the molecules in one direction, would thus result in strong inhomogeneity in the refractive index, the refractive index being strongly linked to dipoles.

The above discussed phosphorus and sulphur based chalcogenide materials are suitable for use in a WORM type recording medium, as the photo-induced change in refractive index is substantially irreversible. Although the raw material has good transparency to an Nd-YAG laser, for samples above 100 μm in thickness, it would be preferable to obtain even thicker samples of the order of 0.5 mm for improved multiplexing purposes and with further improved transparency.

A type of chalcogenide material suitable for a re-writeable holographic data storage medium is discussed in WO 01/45111. Such a material contains molecular cluster compounds of the type A₄B₃ or A₄B₄ (A=P,As and B=S, Se, Te) embedded in an amorphous chalcogenide host material. When an interference pattern is formed within this medium via means of illumination with coherent linearly polarized light, in the light areas of this interference pattern the molecular units orient themselves with respect to the electric field vector of the linearly polarized light, thereby causing a preferential overall redistribution of refractive index in the illuminated areas, forming a volume phase hologram and other holographic elements within the medium. An example of such a medium can be prepared via thermal evaporation of a melt of As and Se elements with a respective molar ratio of 4:3. Evaporation of the melt onto an amorphous silica substrate in high vacuum with an evaporation rate of 1-3 nanometers per second produces a thin film material consisting of an amorphous network with embedded molecular units of As₄Se₃. The concentration of the molecular unit phase is dependent on conditions such as temperature of the melt, temperature of the substrate, molar ratio of the elements in the melt, rate of evaporation, subsequent thermal treatment of the treated film etc.

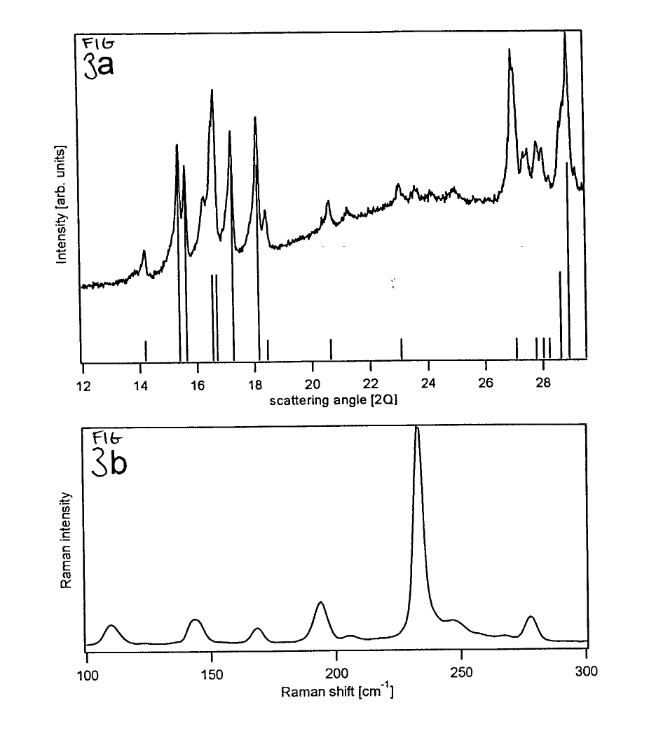

For example, at sufficiently slow evaporation rates (approximately 0.1 nm/s), it is possible to obtain nearly 100% crystalline phase composed of As₄Se₃ molecules. FIG. 3a shows an x-ray diffraction pattern of a thin film prepared by very slow evaporation (<<1 nm/sec) of As₄Se₃ bulk material. Compared with the result of Blachnik and Wickel, (1984 Thermochimica acta 81, 185), it is found that the major substance in the prepared film are the α-As₄Se₃ molecules. FIG. 3b shows corresponding Raman spectra of the As₄Se₃ film prepared with a very slow evaporation rate. Also, comparison with literature values shows that the major substance in the prepared films are the As₄Se₃ molecular crystals (Bues W., Somer M. and Brockner W. 1980 Zeitschrift fur Naturforschung, 35b, 1063-1069).

When subjected to increased temperatures, crystals consisting entirely of a packing of the As₄Se₃ or As₄Se₄ molecules transform into the plastically crystal-like state. The intermolecular forces in the plastic phase are weakened in such a way that these molecules can be relatively freely oriented within the medium under the influence of an external field of typically thermal or mechanical origin. It has now been found that it is possible, repeatedly and reversibly, or permanently if desired, directionally to orient and align the molecules in such a plastic phase of a corresponding molecule containing glass by illumination with polarized light. This preferential reorientation of the molecular units can be preserved in the glass after cooling the holographic medium to temperatures below the temperature associated with the plastic phase change of the molecules. Hence, this medium can be used as a rewritable holographic recording medium.

He—Ne laser light (633 nm) is generally required to achieve the necessary optical penetration in this material in order to multiplex multiple pages of data. This is because the As—Se material has a much lower bandgap than the above described phosphorous and sulphur-based material. In the arsenic and selenium based material, absorption of 532 nm light from a Nd:YAG laser is very high and writing with such a laser is not practicable unless the medium is effectively diluted.

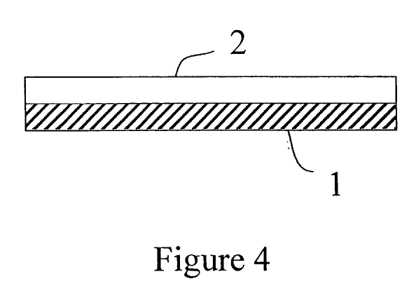

FIG. 4 illustrates the construction of a holographic recording medium according to the present invention having a substrate 1 which may be any suitable transparent material such as a polymer (eg. polycarbonate) or optical glass and an amorphous layer 2 of a chalcogenide material, which may be any of the above examples diluted with a filler material. The present invention concerns the dilution of the above mentioned compositions to achieve optically thick amorphous layers which are sufficiently transparent to light from a frequency doubled Nd:YAG laser to allow multiplexing of multiple pages of data.

It is by no means straightforward to dilute active chalcogenide film. The inert matrix must have a similar physical and chemical characteristic to the chalcogenide film. For example, substantially different thermal expansion coefficients could cause cracking in the film. The matrix would also need to adapt to potential products of the photoinduced reaction of the chalcogenide atoms. Also, isolated regions of chalcogenide material randomly distributed in the matrix of the inert material might even be prohibited from undergoing a photoinduced structural change if the matrix is a very rigid material.

As well as achieving an increase of the optical transmission of diluted chalcogenide-containing thick films, the codeposition method can be used to maximise the particular chalcogenide entities within the material which are optically active. These include the A₄B₃ and A₄B₄ molecules.

It is not possible to prepare amorphous films containing only these molecules as these films have a very strong tendency to crystallize, as in the above discussed example of an As₄Se₃ film formed with a low evaporation rate. This is undesirable in a holographic recording medium, as crystal boundaries in the material cause appreciable light scattering which degrades holographic read out efficiency. A film of the same As₄Se₃ material diluted with YF₃ has been found to be perfectly amorphous.

Possible filler materials include YF₃, ZnS, GeO₂ and B₂O₃. Another example can be a chalcogenide glass having a larger bandgap (and hence different composition) than that of the molecular species. The preferred method of preparation is by coevaporation of the chalcogenide bulk material and a filler in two separate crucibles, and depositing the mixture as an amorphous layer onto the substrate. The means of evaporation may be thermal evaporation, chemical vapour deposition electron beam evaporation, or laser ablation, or a combination such as e-beam for the filler and thermal for the chalcogenide. The principle is to evaporate both entities from separate crucibles to prevent chemical reaction in the melt. The mixing of the active material with the filler occurs in the vapour phrase inside the evaporation chamber or on the substrate itself.

A holographic recording medium was prepared using YF₃ and As₄Se₃ using a ratio between 1:10 to 1:100 (As₄Se₃:YF₃). Both substances were evaporated from molybdenem boats in vacuum of approximately 3×10⁻⁴ Pa at evaporation rates of about 1 nm/sec. The mixture was condensed onto a silica substrate.

It has been found that ratios of 1:1 or 1:2 (chalcogen:filler) are not possible as the stresses in the material are too great due to differences in thermal expansion coefficients. Also, such ratios seem to lead crystallisation of the molecular units. Ratios of 1:4 or 1:5 and less appear generally to work well.

As well as co-evaporation, a possible method is to use in sputtering two (or more) separate targets or a target wherein the two substances are mixed in powders and sputtered.

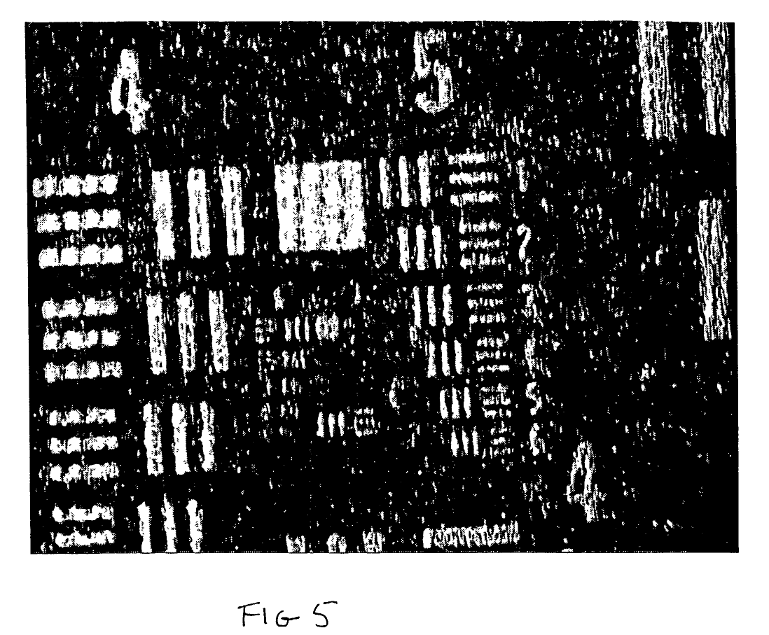

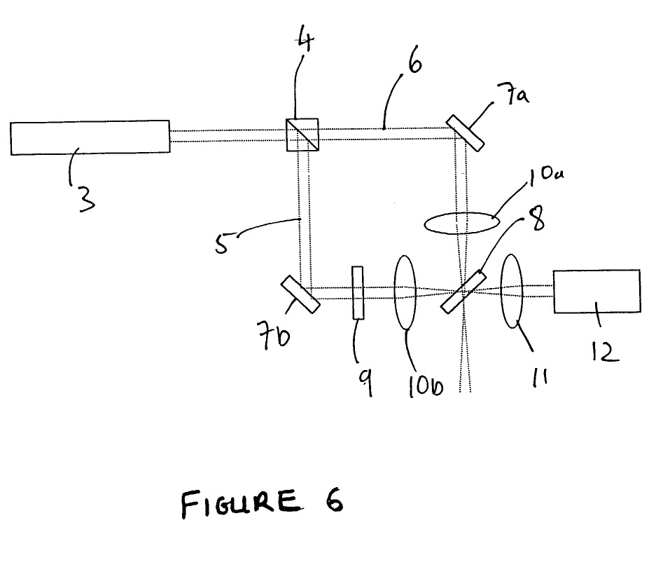

FIG. 5 is a hologram recorded in a film comprising active As₂S₃ glass diluted with ZnS filler. FIG. 6 illustrates the apparatus used to record the hologram of FIG. 5. A beam from an Nd:YAG laser 3 is split by beam splitter 4 into object beam 5 and reference beam 6, which are reflected by mirrors 7a, 7b. The object beam 5 passes through the image plate 9, in this case being the US Air Force military resolution target. Both beams are focused by lenses 10a, 10b and the interference pattern of the two intersecting light beams is recorded in the medium 8. Lens 11 focuses the read-out image onto a CCD camera 12 to record the image.

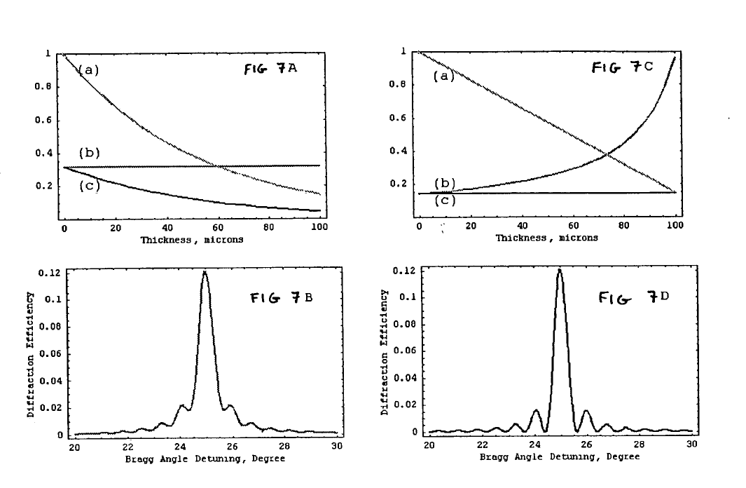

The present inventors have found that a further improved holographic recording medium can be produced by inhomogenously diluting the chalcogenide material. The principle behind the nonhomogenous dilution is illustrated in FIGS. 7A to 7D. FIGS. 7A and 7B illustrate a homogenously diluted film. In FIG. 7A, the x axis shows the thickness of the material (in this case 100 micrometers) and the y axis is normalised to the appropriate curves. Curve (a) shows the exponential absorption losses of the incident light intensity throughout the thickness of the material. Curve (b) shows a concentration profile of the chalcogenide glass through the thickness of the material, which in this case is constant. Curve (c) shows the resulting exponential refractive index modulation throughout the thickness. If a diffraction grating (a hologram) is written in the homogenously diluted film, the angular diffraction efficiency shown in FIG. 7B is recorded.

FIGS. 7C and 7D show equivalent results for an inhomogenously diluted film. Curve (b) shows that the chalcogenide content of the film substantially hyperbolically increases throughout the thickness of the film. The result is that the refractive index change upon illumination within incident light remains substantially constant through the thickness of the film (c). FIG. 7D shows the resulting angular diffraction efficiency of a diffraction grating written in such a film. It should be noted that the total concentration of absorbing species (chalcogenide glass) in both the homogenously and inhomogenously diluted films are the same i.e. the average absorption coefficient is the same.

Any concentration profile having an increase in concentration with depth will have some effect in compensating for absorption, but the present inventors have found a generally hyperbolic increase to be most effective.

Comparing FIGS. 7B and 7D, it can be seen that the minima in Bragg selectivity curves are shifted to zero in the case of the inhomogenously distributed chalcogenide film. The increase of the level of the minima in FIG. 7B is a major contributor to noise in multiplexed holograms and in principal can limit the minimum distance (in the case of shift multiplexing) or angle (in the case of angle multiplexing) at which subsequent holograms are recorded in the media. In other words it is a limiting factor in overall data density. By inhomogenously diluting the film to compensate for absorption as illustrated in FIG. 7C, it is possible to make highly absorbing holographic media that are much thicker with a better signal to noise ratio than a homogenously diluted film. The thicker medium allows a much higher Bragg selectivity, again allowing higher data density. By increasing the thickness, and hence the absorption, the sensitivity is also increased. In order to achieve a given absorption, a certain concentration of active species is required, but the absorption cannot be increased too much as the film would not be transparent and the Bragg minima would be too high for any effective multiplexing. By varying the concentration profile, the transmission is effectively decreased by increasing the concentration of active species without being bound by the 50% limit because the Bragg minima would not be uplifted any more. Therefore, by increasing the concentration the sensitivity is increased.

The concentration profile can be achieved by varying the evaporation rates of chalcogenide material and filler material during deposition of the film. As deposition begins, the rate of evaporation of chalcogenide material is high, and the rate is decreased as the films thickness increases. Conversely, the rate of evaporation of filler starts low and increases as the rate of evaporation of chalcogenide material decreases.

1. A holographic recording medium comprising an amorphous mixture of a chalcogenide glass and a filler material, the filler material being substantially transparent to visible light, wherein the chalcogenide glass undergoes a photostructural change in response to illumination resulting in a change of refractive index of the chalcogenide glass.

2. A holographic recording medium according to claim 1, wherein the filler material comprises a glass.

3. A holographic recording medium according to claim 2, wherein the filler comprises an oxide, fluoride or chalcogenide glass.

4. A holographic recording medium according to claim 3, wherein the filler comprises YF₃, ZnS, B₂O₃ or GeO₂.

5. A holographic recording medium according to claim 2, wherein the glass filler has a band gap of at least 2.6 eV.

6. A holographic recording medium according to claim 1, wherein the amorphous chalcogenide mixture contains molecules of A₄B₃ and/or A₄B₄ where A is either phosphorus or arsenic and B is either sulphur or selenium.

7. A holographic recording medium according to claim 1, wherein the chalcogenide glass comprises at least sulphur in combination with phosphorus.

8. A holographic recording medium according to claim 7, wherein the photostructural change is the breakdown of P₄S₄ and/or P₄S₃ molecules in the glass.

9. A holographic recording medium according to claim 7, wherein the chalcogenide glass further comprises an element selected from the group consisting of As, Ge, Ga, B, Si, Al, Zn.

10. A holographic recording medium according to claim 1, wherein the chalcogenide glass consists of sulphur, phosphorus and arsenic.

11. A holographic recording medium according to claim 1, said medium comprising a substrate and a layer of the amorphous mixture.

12. A holographic recording medium according to claim 11, wherein the layer has a thickness of at least 100 μm.

13. A holographic recording medium according to claim 11, wherein the layer has a thickness of at least 400 μm.

14. A holographic recording medium according to claim 12, wherein the layer has an optical transmission of greater than 50% for light at a wavelength of 532 nm.

15. A holographic recording medium according to claim 1, wherein the concentration of the chalcogenide glass in the mixture is varied throughout the mixture to compensate for absorption of illuminating light.

16. A holographic recording medium according to claim 15, wherein the concentration of the chalcogenide glass increases with increasing distance from a surface of the recording medium.

17. A holographic recording medium according to claim 16, wherein the concentration increases substantially hyperbolically.

18. A method of producing a holographic recording medium comprising the steps of:
co-depositing a chalcogenide material and a filler material onto a substrate to form an amorphous film comprising an amorphous mixture of a chalcogenide glass and a filler material, the filler material being substantially transparent to visible light.

19. A method of producing a holographic recording medium according to claim 18, wherein the step of codepositing comprises co-sputtering the chalcogenide material and the filler material from separate sources.

20. A method of producing a holographic recording medium according to claim 18, wherein the step of codepositing comprises coevaporating the chalcogenide material and the filler material from separate receptacles and condensing the vapour on the substrate to form the amorphous mixture.

21. A method of producing a holographic recording medium according to claim 20, wherein the amorphous layer is greater than 100 μm thick.

22. A method of producing a holographic recording medium according to claim 20, wherein the amorphous layer has an optical transmissivity greater than 50% at 532 nm.

23. A method of producing a holographic recording medium according to claim 18, wherein the ratio of chalcogen to filler is 1:4 or a more diluted chalcogen film.

24. A method of producing a holographic recording medium according to claim 18, wherein the chalcogenide material and the filler material are deposited such that the concentration of the chalcogenide material in the film varies throughout the depth of the film.

25. A method of producing a holographic recording medium according to claim 24, wherein the chalcogenide material and the filler material are deposited such that the concentration of the chalcogenide material increases with increasing distance from a surface of the film.

26. A method of producing a holographic recording medium according to claim 25, wherein the concentration of the chalcogenide material increases substantially hyperbolically with increasing distance from the surface.

27. A method of holographic recording comprising the steps of:
providing a holographic recording medium comprising an amorphous mixture of a chalcogenide glass and a filler material, the filler material being substantially transparent to visible light;
selectively illuminating the holographic recording medium thereby inducing a photostructural change resulting in a change of refractive index of the chalcogenide glass.

28. A method of holographic recording according to claim 27, wherein the illuminating light has a wavelength of substantially 532 nm.

29. A method of holographic recording according to claim 27, wherein the holographic recording medium is illuminated by a frequency doubled Nd:YAG laser.

30. A method of holographic recording according to claim 27, wherein the holographic recording medium is illuminated by a pulsed laser.

31. A method of holographic recording according to claim 27, wherein the illuminating light causes a breakdown of A₄B₄ and/or A₄B₃ molecules in the glass.

32. A method of holographic recording according to claim 27, wherein the illuminating light is polarised.

33. A method of holographic recording according to claim 32, wherein the illuminating light causes a reorientation of A₄B₃ and/or A₄B₄ molecules in the glass, where A is either phosphorus or arsenic and B is either sulphur or selenium.
